(19) United States
(12) Patent Application Publication
(10) Pub. No.: US 2016/0129913 A1
(43) Pub. Date: May 12, 2016

(54) System and Method for the Automatic Persona Identification of a Person Post Motion

(71) Applicant: Lars Boesen, Woodinville, WA (US)

(72) Inventor: Lars Boesen, Woodinville, WA (US)

(21) Appl. No.: 14/932,523

(22) Filed: Nov. 4, 2015

Related U.S. Application Data
(60) Provisional application No. 62/076,021, filed on Nov. 6, 2014.

(51) Int. Cl. B60W 40/09; H04L 29/08; H04M 1/725; G06Q 40/00; G06Q 30/06; G06Q 20/14; G06Q 30/00; H04W 4/04; G06Q 40/08

(52) U.S. Cl. CPC B60W 40/09; H04W 4/046; H04L 67/306; H04M 1/72522; G06Q 40/08; G06Q 30/0645; G06Q 20/14; G06Q 30/018; G06Q 40/123

(57) ABSTRACT

A method for using a sensor device such as a smartphone that a user/person already carries for recording motion data and change in location used to match one of several specific user profiles based on actions at the destinations and behavior prior to arrival. The present invention requires no ODB or beacon external connections to predict when a smartphone user is the driver or the passenger based on exit direction after arriving at a destination and validated by specific behavior in the vehicle/car. This outcome is improved over time using machine learning based on user correction of proposed status. The present invention correctly predicts a user status based on geo motion after a specific state or specific location—end location—has been reached. The method then profiles a person as “driver” or “passenger” based on persons exit direction at end of trip.

### CROSS REFERENCE TO RELATED APPLICATIONS

This application claims priority from U.S. Patent Application Ser. No. 62/076,021, entitled “System and Method for the Automatic Persona Identification of a Person Post Motion”, filed on 6 Nov. 2014. The benefit under 35 USC §119(e) of the United States provisional application is hereby claimed, and the aforementioned application is hereby incorporated herein by reference.

### SEQUENCE LISTING OR PROGRAM

Not Applicable

### TECHNICAL FIELD OF THE INVENTION

The present invention relates generally to personal identification. More specifically, the present invention relates to a means to identify a person's persona based on motion data.

### BACKGROUND OF THE INVENTION

It is often desirable to deliver relevant and timely information to selected individuals such as consumers. Several approaches have been used to aid in the delivery of targeted information to selected individuals. For example, information has been delivered via electronic means to individuals who are present with their smart phones or other devices in a particular location. Consumers with a smart phone or other device who are present within a certain distance from a vendor may receive targeted information.

The prior art also teaches where trips are driven by cars but not about who is driving the car. The prior art bases their business model assuming anyone in the car is the driver, but the Inventor's research from the US shows at least 21.5% were passengers (likely even more in developing markets) and this makes for significant noise in the collected data.

Additionally, the identification of a person based on their past motion history is also desirable, not only for the delivery of target information, but as a means of identification. In the prior art, the collection and use of such past motion history and the collection of such data is completed by using one or more sensors such as an ODB device connected to a vehicle.

Until now, an ODB-II device had to be connected to a car electric system and wirelessly to a smartphone to receive the motors signal that the phone is in the car proximity and that the engine was first started and then stopped. This defined an end of trip but not whether the smartphone owner was the driver or passenger.

An additional sensor such as an iBeacon could be installed in car and connected to a smartphone to identify phone users location in car vs the device. Together this would possibly predict when a smartphone user is the driver but require multiple devices installed and communicating at the same time creating a complex support environment and does not transfer well if a user drives different cars at different times. Also, when drivers use rental and car sharing vehicles there would be no specific i-beacon so these trips would likely be missed.

A smartphone only solutions using motion sensor, GPS, satellite, or cell tower signal to track motion e.g. start and stop of a trip, such solutions hasn't differentiated between a person being a passenger or a driver—e.g. did a passenger get seen as a driver when they drove in car. This pollutes their driving score reputation which can be important for apps logging their drives and e.g. insurance issuers as it impact user statistics and create uncertainty in the provided data. Similarly, mileage refund for one trip where people share a car easily means multiple payments for a company for a cost only derived once.

Therefore, what is needed is a new system and method for collecting, recording, using, and transmitting present, past, and future motion data of a user that does not require the expense and complication of one or more sensors, but is used in combination with current technology, such as a smartphone, that many potential users of the data already have on their person.

### DEFINITIONS

An “accelerometer” is a device that measures proper acceleration (“g-force”). Proper acceleration is not the same as coordinate acceleration (rate of change of velocity).

The APPLE M7 (codename Oscar), M8, and M9 are motion coprocessors used by APPLE Inc. in their mobile devices. Their function is to collect sensor data from integrated accelerometers, gyroscopes and compasses and offload the collecting and processing of sensor data from the main central processing unit (CPU).

“Application software” or “software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society.

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

A compass is an instrument used for navigation and orientation that shows direction relative to the geographic cardinal directions, or “points”. Usually, a diagram called a compass rose, shows the directions north, south, east, and west as abbreviated initials marked on the compass.

“Electronic Mobile Device” is defined as any computer, phone, or computing device that is comprised of a battery, display, circuit board, and processor that is capable of processing or executing software. Examples of electronic mobile devices are smartphones, laptop computers, and table PCs.

The Global Positioning System (GPS) is a space-based navigation system that provides location and time information in all weather conditions, anywhere on or near the Earth where there is an unobstructed line of sight to four or more GPS satellites.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

A gyroscope (from Greek γ\tilde{ν}ρoζ gûros, “circle” and σκo π\acute{ε}ω skopéō, “to look”) is a spinning wheel or disc in which the axis of rotation is free to assume any orientation. When rotating, the orientation of this axis is unaffected by tilting or rotation of the mounting, according to the conservation of angular momentum. Because of this, gyroscopes are useful for measuring or maintaining orientation. Applications of gyroscopes include inertial navigation systems where magnetic compasses would not work (as in the Hubble telescope) or would not be precise enough (as in intercontinental ballistic missiles), or for the stabilization of flying vehicles like radio-controlled helicopters or unmanned aerial vehicles, and recreational boats and commercial ships.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “motion detector” is a device that detects moving objects, particularly people. A motion detector is often integrated as a component of a system that automatically performs a task or alerts a user of motion in an area. Motion detectors form a vital component of security, automated lighting control, home control, energy efficiency, and other useful systems. An electronic motion detector contains an optical, microwave, or acoustic sensor, and in many cases a transmitter for illumination. There are several motion detection technologies in wide use: Passive infrared (PIR); Microwave; Ultrasonic; Tomographic motion detector; and Video camera software.

“Persona” is the way a person behaves, talks, etc., with other people that causes others to see the person as a particular kind of person; the image or personality that a person presents to other people. In the present invention, “Persona” is focused on the role a person is playing such asa a buyer or a seller, or a driver or a passenger in a vehicle. The present invention helps define a more accurate reputation system for e.g. drivers and passengers.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

A “User” is any person registered to use the computer system executing the method of the present invention.

A “web application” or “web app” is any application software that runs in a web browser and is created in a browser-supported programming language (such as the combination of JavaScript, HTML and CSS) and relies on a web browser to render the application.

“Wi-Fi”, also spelled Wifi, WiFi, or wifi, is a local area wireless technology that allows an electronic device to exchange data or connect to the internet using 2.4 GHz UHF and 5 GHz SHF radio waves. The name is a trademark name, and is a play on the audiophile term Hi-Fi. The Wi-Fi Alliance defines Wi-Fi as any “wireless local area network (WLAN) products that are based on the Institute of Electrical and Electronics Engineers' (IEEE) 802.11 standards”.[1] However, since most modern WLANs are based on these standards, the term “Wi-Fi” is used in general English as a synonym for “WLAN”. Only Wi-Fi products that complete Wi-Fi Alliance interoperability certification testing successfully may use the “Wi-Fi CERTIFIED” trademark

### SUMMARY OF THE INVENTION

The present invention is a method for the identification of a person based on their past motion history. The method of the present invention uses a sensor device such as a smartphone that a user/person is already carrying. Then, after traveling or reaching a specific location, the current motion data and past motion data are used to match one of several specific user profiles based on actions at the destinations and behavior prior to arrival. The method of the present invention teaches this using sensor data collected through a smartphone device itself and from radio signals collected by smartphone.

The present invention requires no ODB or beacon external connections to predict when a smartphone user is the driver or the passenger based on exit direction after arriving at a destination and validated by specific behavior in the vehicle/car. This outcome is improved over time using machine learning based on user edits or corrections of proposed status.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the method of the present invention for the automatic persona identification of a person post motion;

FIG. 2 is a sketch illustrating a first destination scenario of the present invention; and

FIG. 3 is a sketch illustrating a second destination scenario of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention is practiced. These embodiments are described in sufficient detail to enable those skilled in the art to practice the invention, but other embodiments is utilized and logical, mechanical, electrical, and other changes is made without departing from the scope of the present invention. The following detailed description is, therefore, not to be taken in a limiting sense, and the scope of the present invention is defined only by the appended claims.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

The present invention is a method for the identification of a person based on their past motion history. The method of the present invention uses a sensor device such as a smartphone that a user/person is already carrying. Then, after traveling or reaching a specific location, the current motion data and past motion data are used to match one of several specific user profiles based on actions at the destinations and behavior prior to arrival. For example, the collected data can be used to determine if the user/person was the driver or the passenger after a car trip or a shopper or pedestrian after watching a display window. The method of the present invention teaches this using sensor data collected through a smartphone device itself and from radio signals collected by smartphone.

The present invention requires no ODB or beacon external connections to predict when a smartphone user is the driver or the passenger, but bases this decision and assignment of persona on specific behavior in car. This outcome is improved over time using machine learning based on user edits of proposed status.

The solution of the present invention results in higher quality data from a single device solution at lower cost and simplicity. The present invention provides rapid deployment of scale with low support cost as only requirement is existing smartphone device and download of an app in an existing app store. No data plan is required. Accurate driver statistics across multiple transportation modes e.g. multiple cars, taxi, rental car, car sharing, motorcycle enabling more precise costing for both current (car insurance) and new business models such as usage based insurance and car sharing and builds a reputation model and score to be used to document driving proficiency for professional drivers, job applicants.

In one embodiment, to predict when a smartphone user is the driver or the passenger based on exit direction after arriving at a destination and validated by specific behavior in car such as charging, which predicts front row location and the main user of car; long use of cell phone while driving in high speed predicts a passenger; past travel patterns.

An example of this embodiment is when a person has previously acknowledged to have driven as driver e.g. 90% of the time to the same destination at e.g. 8 AM on Mondays, prior driving style from other trips identifying driver, such as similar acceleration after stops; and user behavior and profile by other app users in the same vehicle. Using these factors, the method can make a decision on whether to classify the user/person as a driver or passenger in the vehicle with a higher degree of certainty.

By measuring device use in combination with motion data it is possible to predict intense use of tapping related to email and text messaging by collecting a devices gyroscope. The present invention may also use the occurrence or case of recording gyroscope data over a longer period while a device is traveling at high speed (10-150 mph range) to predict passenger vs driver as one functional step of the method of the present invention.

The present invention correctly predicts a user status based on geo motion after a specific state or specific location—end location—has been reached. The method then profiles a person as “driver” or “passenger” based on the persons exit direction at end of trip defined as X+n meters, X and X−y meters where n is defined as distance after user has taken z steps walking, y is the angle in degrees measuring a user/person's exiting direction from a vehicle, and X is defined as location where vehicle has reached zero speed.

In the US, a 200 person questioner research performed by the inventors, showed 80% of people last time in the car were driving alone. 15% of the time they were a passenger in front seat and only 5% of people were in the back seat. Of these 5%, 80% exit through the right back door. Meaning 1% of will use left back door to exit and would with this invention report a False Positive as a driver. This implies the present invention can improve driver data collection from 80% accuracy to a +99% accuracy.

For certain segments, the young or females, research shows the data improvement appears to be even higher. The inventors will overcome the False Positive by using secondary indicators such as was phone charged while in motion, is the user predominantly driver in the past, time of day vs prior trips on the same route, etc.

The method of the present invention is embodied as a software application or App and uses a phones location services to identify a trip start and a trip end. In an IPHONE, the App uses APPLE's iOS CLLocationManager to initiate, record and complete trip. At the Start of a Trip 101, once the app is on and the location services are enabled, the App starts listening to the GPS and sensor data. Trip will start when speed exceeds predefined speed. and will continue to run until an end of trip or trip change is detected 102. A change in trip or end of trip is typically determined by a reduction in travel speed below 1 mile per hour for a predefined period 103. Once this occurs, the App. starts the end of trip method.

At the End of Trip, when the App detects that the speed is reduced below 1 mile per hour, the method of the present invention enables analysis of various motion sensor data input to conclude with certainty a trip has completed 104.

Once the motion manager is activated 105, the App, in an IPHONE embodiment, switches the location services to use CLLocationManager to start collect GPS data 105. Trips which are 1 minute apart get merged into one 113.

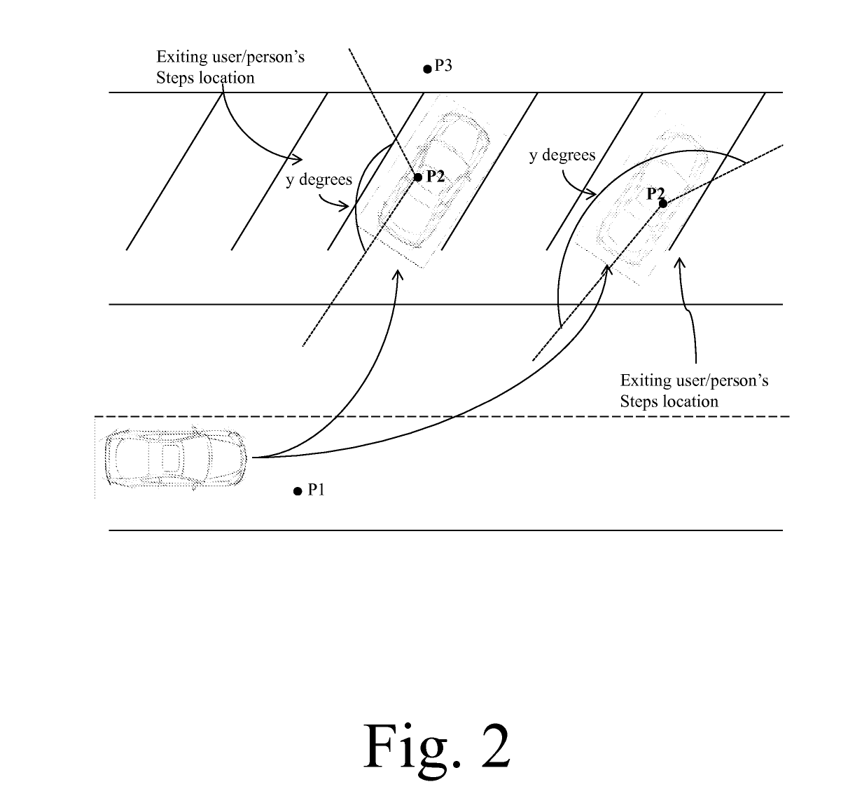

Now referring to FIG. 2, a first GPS point used is at a location at x meters before the end of a trip P1 106. A second point when speed reaches zero, P2 107. A third point P3 when a person has taken x steps after trip has terminated 108. The Trip end will happen if at least seven steps are recorded 109. A slope is calculated for P1 to P2 and P2 to P3 110. An Angle is calculated between these two slopes 111. The user/person's exit is right if the angle is greater than 180 degrees and left if less than 180 degrees as shown in the FIG. 2 112.

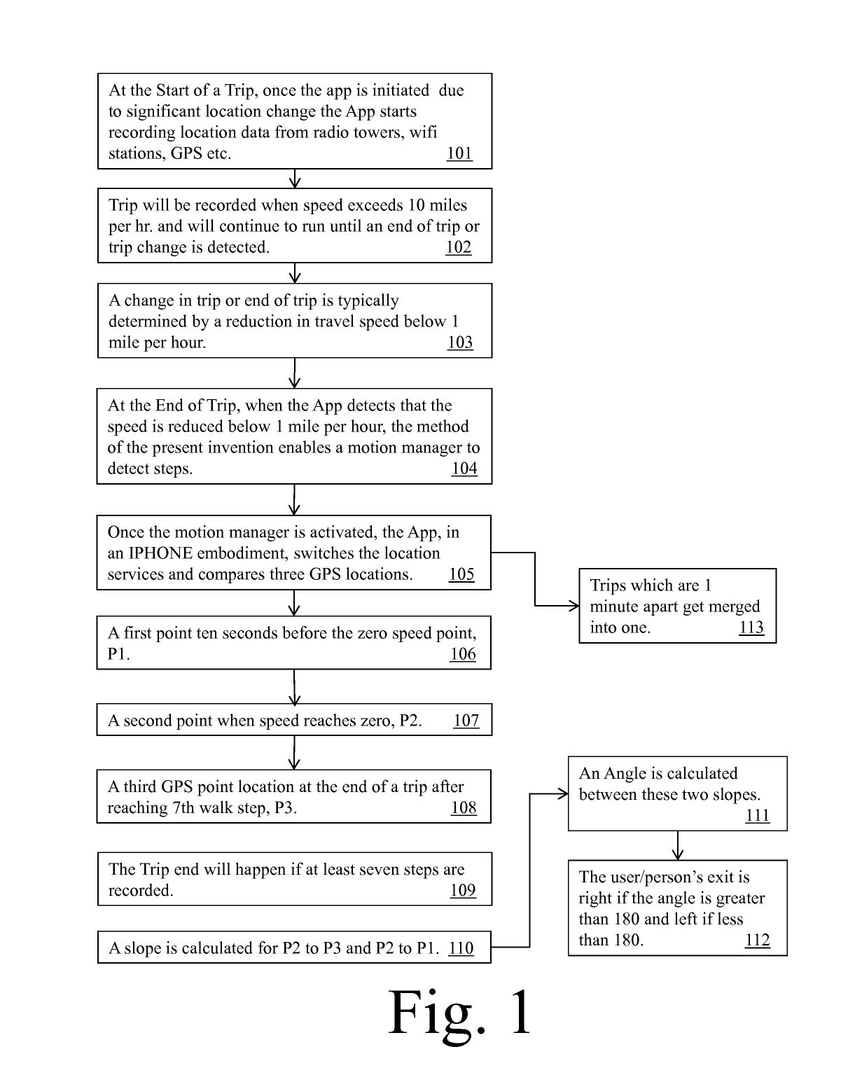

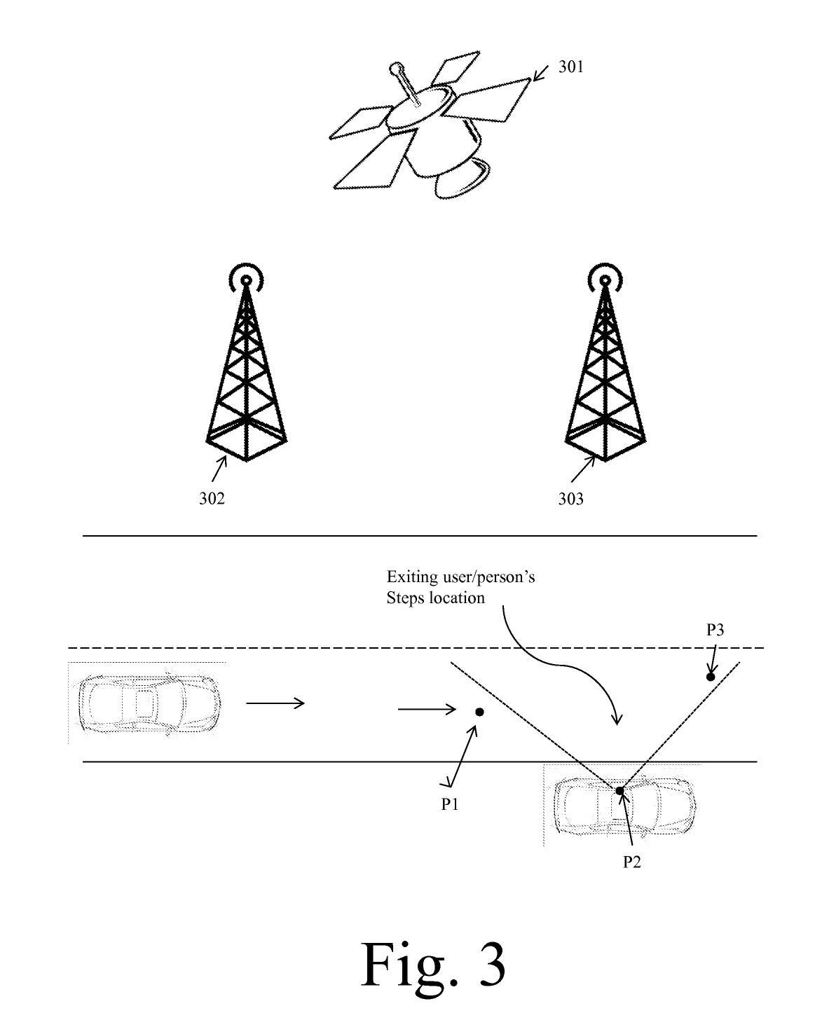

FIG. 3 is a sketch illustrating a second destination scenario of the present invention. In this scenario, location points and GPS data are provided by satellites 301 or triangulation by two or more cell towers 302 and 303. The process is the same as shown in FIGS. 1 and 2 with respect to the determination of the end of a trip P1, a second point when speed reaches zero P2, and a third point P3 when a person has taken x steps after the trip has terminated. A slope is calculated for P1 to P2 and P2 to P3. An Angle is calculated between these two slopes. The user/person's exit is right if the angle is greater than 180 degrees and left if less than 180 degrees as shown in FIG. 3.

In another embodiment, the present invention can be readily adapted to provide a pay for use case like car rental or car sharing where it would make sure it's the driver driving the car who has the account with the car rental or car sharing service.

In yet another embodiment, the present invention can be readily adapted to define driving behavior and usage (time of day, total distance, driving style, location) to help define actual driving risk for a UBI or pay per use insurance policy where it would make sure the insurance company bills for the distance driven by the insurance holder easily collected wireless without use of hardware dongle.

In still yet another embodiment, the present invention can be readily adapted to road usage tax where it would assign distance to driver disregard vehicle used easily collected wireless without use of hardware dongle.

In still yet another embodiment, the present invention can be readily adapted to electronic driving license renewal where it would assign a current driving score to driver disregard vehicle used easily collected wireless without use of hardware dongle.

In another embodiment, the present invention can be readily adapted to allow define if device owner was the driver or the passenger in a car involved in an accident or driving while under influence.

In still yet another embodiment, the present invention can be readily adapted to billboard or retail advertising effectiveness where it would measure A/B tests to ensure that the time spent in front of specific destination, such as a billboard or display windows, and the direction of the user after the ad has been displayed to determine if it a viewer proceeded in the store as shopper or away as not interested.

In another embodiment, the present invention can be readily adapted to allow users to earn store credit or achieve bonus when arriving at or moving down store isle as desired.

In another embodiment, the present invention can be readily adapted to allow build incentive programs for good driving behavior tied to store or financial incentives.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

The present invention is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The present invention can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for the automatic persona identification of a person post motion by using non-transitory computer-readable medium capable of execution by a mobile device, the method comprising:
a sensor device;
the sensor device collecting current motion data before, during, and after a trip;
a software application running on the sensor device or data analysis in the cloud;
the software application storing one or more user profiles;
the software application comparing collected motion data to past motion data;
the software application matching one of several specific user profiles based on actions at the destinations and behavior prior to arrival;
using sensor data collected through a smartphone device itself and from radio signals collected by smartphone; and
predicting when a smartphone user is the driver or the passenger of a vehicle during a trip.

2. The method of claim 1, wherein the sensor device is a mobile electronic device.

3. The method of claim 2, wherein the mobile electronic device is a smartphone.

4. The method of claim 1, further comprising the step of:
determining if the user/person was the driver or the passenger after a car trip or a shopper or pedestrian after watching a display window.

5. The method of claim 1, wherein the outcome is improved over time using machine learning based on user correction of proposed status and by comparing user status to other personas outcome and usage pattern while traveling in the same vehicle at the same location.

6. The method of claim 1, wherein the decision and assignment of persona on specific behavior in car.

7. The method of claim 6, further comprising the steps of:
predicting when a smartphone user is the driver or the passenger based on exit direction after arriving at a destination; and
validating the prediction by specific in car behavior.

8. The method of claim 7, wherein in-car behavior includes:
charging, which predicts front row location and the main user of car;
long use of cell phone while driving in high speed predicts a passenger;
past travel patterns;
prior driving style from other trips identifying driver; and
user behavior and profile by other app users in the same vehicle.

9. The method of claim 8, further comprising the steps of:
measuring device use in combination with motion data to predict intense use of tapping related to email and text messaging by collecting a devices gyroscope; and
using the occurrence or case of recording gyroscope data over a longer period while a device is traveling at a speed of 10-150 mph to predict passenger vs driver.

10. The method of claim 1, further comprising the steps of:
predicting a user status based on geo motion after a specific state or specific location—end location—has been reached; and
profiling a person as “driver” or “passenger” based on the persons exit direction at end of trip.

11. The method of claim 10, wherein end of trip is defined as
X+n meters, X and X−y meters;
where n is defined as distance after user has taken z steps walking, and
X is defined as location where vehicle has reached zero speed

12. The method of claim 1, further comprising the steps of:
at the Start of a Trip, once the app is on and the location services are enabled, the App starts recording GPS data;
a trip will be recorded when speed exceeds 10 miles per hr. and will continue to run until an end of trip or trip change is detected;
a change in trip or end of trip is typically determined by a reduction in travel speed below 1 mile per hour;
at the End of Trip, when the App detects that the speed is reduced below 1 mile per hour, the method of the present invention uses motion data to define persona; and
concludes a trip has terminated when the users device has recorded x steps.

13. The method of claim 12, wherein Trips which are less than a set amount of minutes apart get merged into one.

14. The method of claim 12, wherein
once the motion manager is activated, the App, switches the location services and captures three GPS locations;
a first GPS point location at the end of a trip after reaching 7th walk step, P3;
a second point when speed reaches zero, P2;
a third point ten seconds before the zero speed point, P1;
a slope is calculated for P2 to P3 and P2 to P1;
an Angle is calculated between these two slopes; and
the user/person's exit is right if the angle is less than 180 and left if greater than 180.

15. The method of claim 1, further comprising the steps of:
defining driving behavior and usage based on time of day, total distance, driving style, and location to help define actual driving risk for insurance purposes;
calculating an insurance bill for driving activity based on the defined driving behavior;
sending a bill for payment; and
receiving payment for a bill.

16. The method of claim 1, further comprising the steps of:
providing a vehicle for transportation as a rental or shared service to an account holder; and
determining, based on the previous steps, if the driver in control of the transportation is the account holder.

17. The method of claim 1, further comprising the steps of:
defining driving behavior and usage based on time of day, total distance, driving style, and location to help determine a driver score;
assigning a driver score to individual drivers based on the defined driving behavior;
using the driver score to determine driver license renewal;
sending a bill for payment; and
receiving payment for a bill.

18. The method of claim 1, further comprising the steps of:
determining if device owner was the driver or the passenger in a car involved in an accident or driving while under influence.

19. The method of claim 1, further comprising the steps of:
calculating the amount of driving distance for an identified driver;
assign the measured or calculated distance to the identified driver; and
calculating an individual road usage tax for the identified driver.

19. The method of claim 1, further comprising the steps of:
defining driving behavior and usage based on time of day, total distance, driving style, and location to help define actual driving risk for providing incentive programs for good driving behavior; and
connection defined driving behavior to one or more store or financial incentives.
